(19) United States
(12) Patent Application Publication
(10) Pub. No.: US 2018/0363981 A1
(43) Pub. Date: Dec. 20, 2018

(54) SETTER FOR FIRING, AND METHOD FOR MANUFACTURING HONEYCOMB STRUCTURE USING SETTER FOR FIRING

(71) Applicant: NGK INSULATORS, LTD., Nagoya-City (JP)

(72) Inventor: Daniel Yukichi Kitaguchi, Nagoya-City (JP)

(73) Assignee: NGK INSULATORS, LTD., Nagoya-City (JP)

(21) Appl. No.: 16/102,918

(22) Filed: Aug. 14, 2018

Related U.S. Application Data
(63) Continuation of application No. PCT/JP2016/086448, filed on Dec. 7, 2016.

(30) Foreign Application Priority Data
Mar. 24, 2016 (JP) 2016-060437

(51) Int. Cl. F27D 3/00; B01D 46/00; B01D 46/24; B28B 3/20; B28B 11/24; F27D 5/00; C04B 38/00

(52) U.S. Cl. CPC F27D 3/0022; B01D 46/0001; B01D 46/2418; B28B 3/20; B28B 2003/203; F27D 5/0031; C04B 38/0006; B01D 2279/30; B28B 11/243

(57) ABSTRACT

A setter for firing used for firing a honeycomb formed body and interposed between the honeycomb formed body and a shelf plate, the setter for firing including: a setter body part having a honeycomb placement surface at least partially in contact with a formed body end face of the honeycomb formed body and placing the honeycomb formed body on the honeycomb placement surface; and a setter supporting part that is provided below the setter body part and supports the setter body part, wherein a value obtained by dividing an area of the honeycomb placement surface of the setter body part by an area of a setter supporting surface of the setter supporting part that contacts the setter body part is in a range of 1.5 to 20.0.

### BACKGROUND OF THE INVENTION

### Field of the Invention

The present invention relates to a setter for firing and a method for manufacturing a honeycomb structure using the setter for firing. More specifically, the present invention relates to a setter for firing laid under a honeycomb formed body for firing an unfired honeycomb formed body in a firing furnace, and to a method for manufacturing a honeycomb structure using the setter for firing (hereinafter, simply referred to as a “method for manufacturing a honeycomb structure”).

### Description of the Related Art

Conventionally, ceramic honeycomb structures have been used for various applications, such as catalyst carriers for purifying automobile exhaust gas, diesel particulate removing filters, or heat storage bodies for combustion device. The ceramic honeycomb structure (hereinafter, simply referred to as a “honeycomb structure”) is manufactured by adjusting a molding material (kneaded material), extruding the molding material into a desired honeycomb shape by using an extruder, subjecting the extruded material to raw cutting, drying, and finish cutting, and then passing the resultant material through a firing step of firing it at a high temperature.

In the firing step carried out in the method for manufacturing the honeycomb structure, the honeycomb formed body is placed on a shelf plate with one formed body end face directed downwardly and is thrown into a firing furnace together with the shelf plate. At this time, for preventing the honeycomb formed body from adhering to the shelf plate, between the shelf plate and the honeycomb formed body, a planking for firing called “setter” is interposed to prevent the honeycomb formed body and the shelf plate from directly contacting with each other. For the setter, for example, a disk-shaped member obtained by cutting a honeycomb structure, which is obtained by firing a honeycomb fired body, into a predetermined thickness is used. In addition, to prevent a trouble that the setter is broken due to repeated use, a setter called a “press setter” obtained by press molding a ceramic material and firing the molded material is sometimes used. These setters are collectively referred to as a “setter for firing” and defined herein. In addition, the molding material from the extrusion until before the firing is called a “honeycomb formed body”, and the honeycomb formed body fired after passing through the firing step is called a “honeycomb structure”.

The extruded honeycomb formed body is introduced into a firing furnace set to a predetermined firing temperature and subjected to the firing step. At this time, firing shrinkage occurs in a longitudinal direction (axial direction) of a cell of the honeycomb formed body and in a direction orthogonal to the longitudinal direction of the cell. Hence, in a case where the honeycomb formed body is placed on the setter for firing, a displacement may be generated between an upper surface (corresponding to a honeycomb placement surface) of the setter for firing and the formed body end face of the honeycomb formed body due to the firing shrinkage at the time of firing, thus causing troubles, such as “cell deformation” on the formed body end face and “partition wall cut” that is disjuncture of a partition wall.

Further, if catching occurs between the formed body end face and the honeycomb placement surface, the firing shrinkage may not be performed evenly, thus causing shape deformation of the formed body end face. Consequently, in a case of a round pillar-shaped honeycomb structure, a “roundness” defect that a shape of the formed body end face is not a complete round occurs. It is known that the above-described troubles are particularly prominent in a case of a thin partition wall of the honeycomb formed body or at the time of firing of manufacturing a large honeycomb structure with a large honeycomb diameter.

Generally, since the setter for firing is repeatedly used over a plurality of times, it gradually deforms due to exposure to a high firing temperature in the firing furnace, and irregularities are sometimes formed on the honeycomb placement surface of the setter for firing. When these setters for firing with irregularities are used, the above-described troubles, such as cell deformation, tend to occur more prominently. Further, like a honeycomb structure for gasoline particulate filter (GPF) used as a particulate removing filter for a gasoline-fueled automobile, there is a fear that a honeycomb structure easily deforms depending on a used material and a surface shape of the setter for firing in contact with the honeycomb formed body is directly transferred to the formed body end face to degrade a product quality.

To solve the above-described troubles, there is already proposed a setter (a planking for firing) capable of suppressing catching between the honeycomb formed body and the honeycomb placement surface of the setter for firing in contact with the honeycomb formed body and limiting a contact area to a small one (for example, refer to Patent Document 1 or 2). These setters avoid occurrence of resistance or restraint of firing shrinkage between the honeycomb formed body and the setter for firing in the firing step by, for example, planarizing the honeycomb placement surface (setter upper surface) or forming the honeycomb placement surface with a curved surface that is raised from a side edge part to a central part, and can manufacture a honeycomb structure which solves the roundness defect without causing cell deformation, partition wall cut, or the like.
[Patent Document 1] JP-A-2000-274954
[Patent Document 2] JP-A-2003-82403

### SUMMARY OF THE INVENTION

However, even in a case where the setter disclosed in Patent Documents 1 and 2 is used, there is a case where the cell deformation or partition wall cut may still occur in the honeycomb structure after firing depending on the firing conditions. Particularly, in a case of manufacturing a large honeycomb structure with a large honeycomb diameter, adjustment of the firing conditions is difficult, and the above-described troubles may occur many times.

Thus, the present invention has been made in view of the above situations and aims to provide a setter for firing that applies a unique creep phenomenon occurring in a ceramic material, maintains a shape of a honeycomb placement surface, and can solve troubles, such as cell deformation and partition wall cut, and a method for manufacturing a honeycomb structure.

### Means for Solving the Problem

According to the present invention, a setter for firing and a method for manufacturing a honeycomb structure which solve the above problem are provided.

[1] A setter for firing used for firing a honeycomb formed body and interposed between the honeycomb formed body and a shelf plate, the setter for firing including: a setter body part having a honeycomb placement surface at least partially in contact with a formed body end face of the honeycomb formed body and placing the honeycomb formed body on the honeycomb placement surface; and a setter supporting part that is provided below the setter body part and supports the setter body part, wherein a value obtained by dividing an area of the honeycomb placement surface of the setter body part by an area of a setter supporting surface of the setter supporting part that contacts the setter body part is in a range of 1.5 to 20.0.

[2] The setter for firing according to [1], wherein a height of the setter supporting part from a supporting part lower surface that contacts the shelf plate to the setter supporting surface is in a range of 0.5 mm to 5.0 mm.

[3] The setter for firing according to [1] or [2], wherein the setter body part is a ceramic press setter.

[4] The setter for firing according to any of [1] to [3], wherein the setter body part and the setter supporting part are monolithically formed.

[5] The setter for firing according to any of [1] to [4], wherein the honeycomb placement surface has a flat part that contacts the formed body end face and a curved surface part that is formed around the flat part and formed with a bulged curved surface that is raised from a body part side face to an outer edge of the flat part, and a surface roughness of the flat part is not more than 10 μm.

[6] The setter for firing according to any of [1] to [5], wherein at least one of the honeycomb placement surface of the setter body part and the setter supporting surface of the setter supporting part exhibits a circular shape.

[7] The setter for firing according to any of [1] to [6], wherein at least one of the setter body part and the setter supporting part is mullite.

[8] A method for manufacturing a honeycomb structure using a setter for firing, the method including: a molding step of extruding a honeycomb formed body from a molding material; and a firing step of firing the honeycomb formed body obtained by the molding step, the firing step having a shelf plate arrangement step of arranging a shelf plate in a firing furnace, a setter for firing installation step of installing the setter for firing on the arranged shelf plate with the setter supporting part facing the shelf plate, the setter for firing including a setter body part having a honeycomb placement surface at least partially in contact with a formed body end face of the honeycomb formed body and capable of placing the honeycomb formed body on the honeycomb placement surface, and a setter supporting part that is provided below the setter body part and supports the setter body part, wherein a value obtained by dividing an area of the honeycomb placement surface of the setter body part by an area of a setter supporting surface of the setter supporting part that contacts the setter body part is in a range of 1.5 to 20.0, and a honeycomb formed body placement step of placing the honeycomb formed body on the setter for firing with the formed body end face directed downwardly and placing the honeycomb formed body in the firing furnace with the setter for firing interposed between the honeycomb formed body and the shelf plate.

The setter for firing of the present invention solves troubles occurring at the time of firing, such as cell deformation and partition wall cut, and can be used for firing a honeycomb formed body to manufacture a honeycomb structure. Further, the method for manufacturing a honeycomb structure of the present invention can prevent reduction in yield at the time of manufacturing the honeycomb structure, achieve reduction in manufacturing cost, and improve manufacturing efficiency.

### BRIEF DESCRIPTION OF THE DRAWINGS

FIG. 1 is a perspective view showing a schematic configuration of a setter for firing of the present invention.

FIG. 2 is a front view showing a schematic configuration of the setter for firing.

FIG. 3 is an exploded perspective view showing a honeycomb formed body, a setter for firing, and a shelf plate before firing.

FIG. 4 is an explanatory diagram showing, when seen from a side, a setter for firing and a honeycomb formed body before firing.

FIG. 5 is a sectional view showing, when seen from a side, a setter for firing and a honeycomb structure after firing.

### DESCRIPTION OF THE PREFERRED EMBODIMENTS

Hereinafter, embodiments of a setter for firing and a method for manufacturing a honeycomb structure using the setter for firing of the present invention are described in detail with reference to the drawings. Note that, the setter for firing and the method for manufacturing a honeycomb structure of the present invention are not limited to the embodiments below, but can be variously changed, modified, and improved in design without deviating from the scope of the present invention.

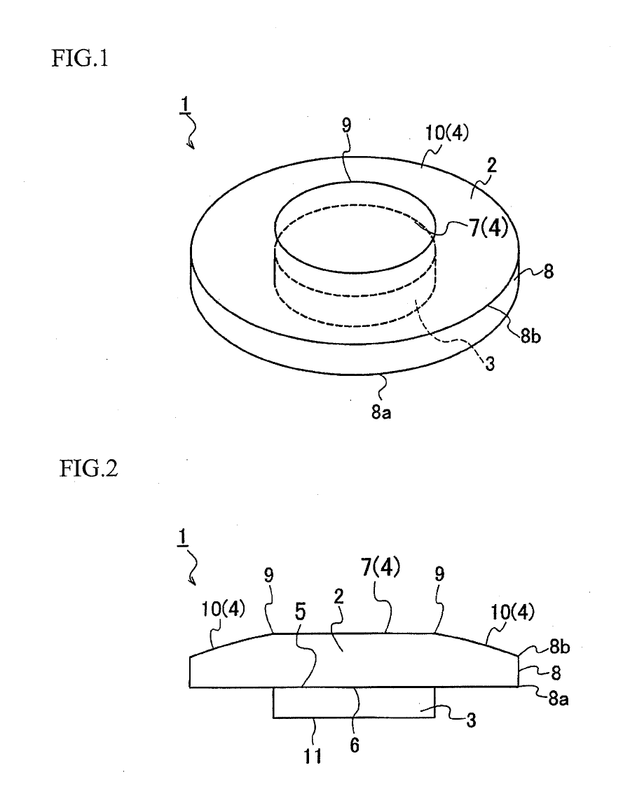

A setter for firing 1 of one embodiment of the present invention mainly includes, as shown in FIGS. 1 to 5, a substantially disk-shaped setter body part 2 and a substantially round pillar-shaped setter supporting part 3 that is provided below the setter body part 2 and supports the setter body part 2. The setter for firing 1 is obtained by firing a honeycomb formed body 100 at a predetermined firing temperature and used in a firing step of a method for manufacturing a honeycomb structure for forming the honeycomb structure (not shown).

Further, the setter body part 2 of the setter for firing 1 includes a honeycomb placement surface 4 that at least partially contacts one formed body end face 101 of a honeycomb formed body 100 to be fired and is positioned on an upper surface side of the setter body part 2, and a body part lower surface 6 that is positioned on a lower surface side facing the honeycomb placement surface 4 and contacts a setter supporting surface 5 on an upper surface side of the setter supporting part 3.

Here, the honeycomb placement surface 4 has a flat part 7 that is formed in substantially the same range as the setter supporting surface 5 of the setter supporting part 3 and is parallel with and along the planar body part lower surface 6 of the setter body part 2, and a curved surface part 10 that is formed around the flat part 7 in a region separate from the setter supporting surface 5 and formed with a bulged curved surface that is raised from a body part side face 8 of the setter body part 2 to a flat part outer edge 9 of the flat part 7. Note that, a diameter D2 of the circular honeycomb placement surface 4 of the setter body part 2 is set to be smaller than a diameter D1 (corresponding to the honeycomb diameter) of the circular formed body end face 101 of the honeycomb formed body 100 to be placed.

Meanwhile, the setter supporting part 3 includes the setter supporting surface 5 that contacts the setter body part 2 and a supporting part lower surface 11 that is provided on a lower surface side facing the setter supporting surface 5 and contacts a shelf plate 102. Here, a diameter D3 of the setter supporting surface 5 of the setter supporting part 3 is set to be smaller than the diameter D2 of the honeycomb placement surface 4 of the setter body part 2 supported by the setter supporting part 3 (D2>D3).

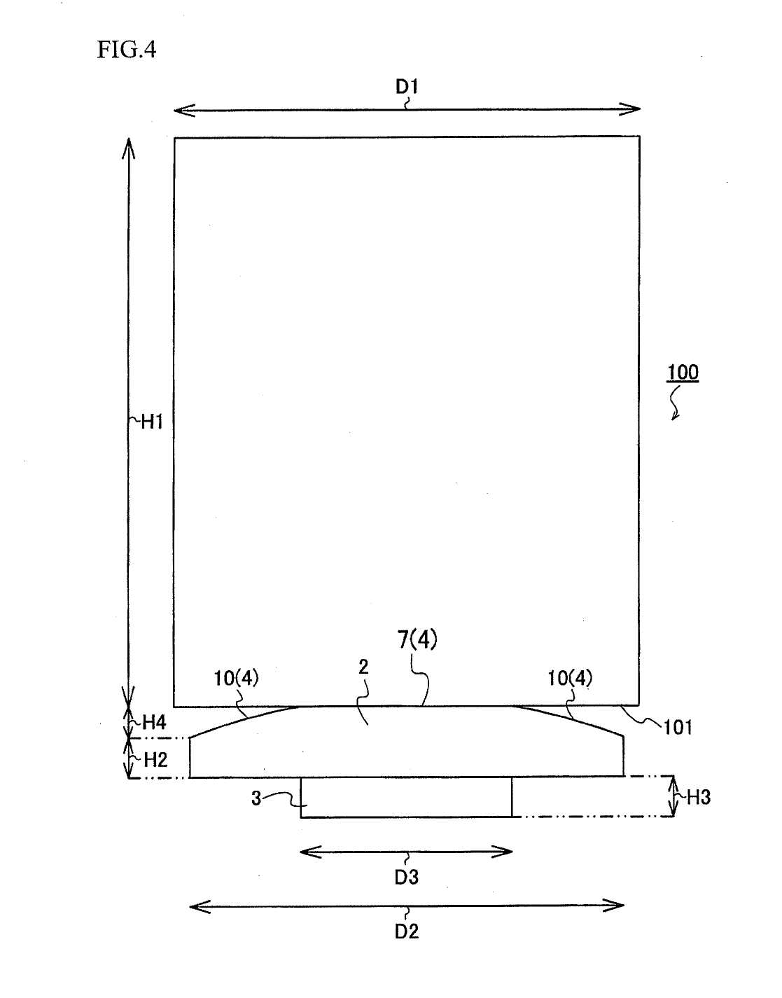

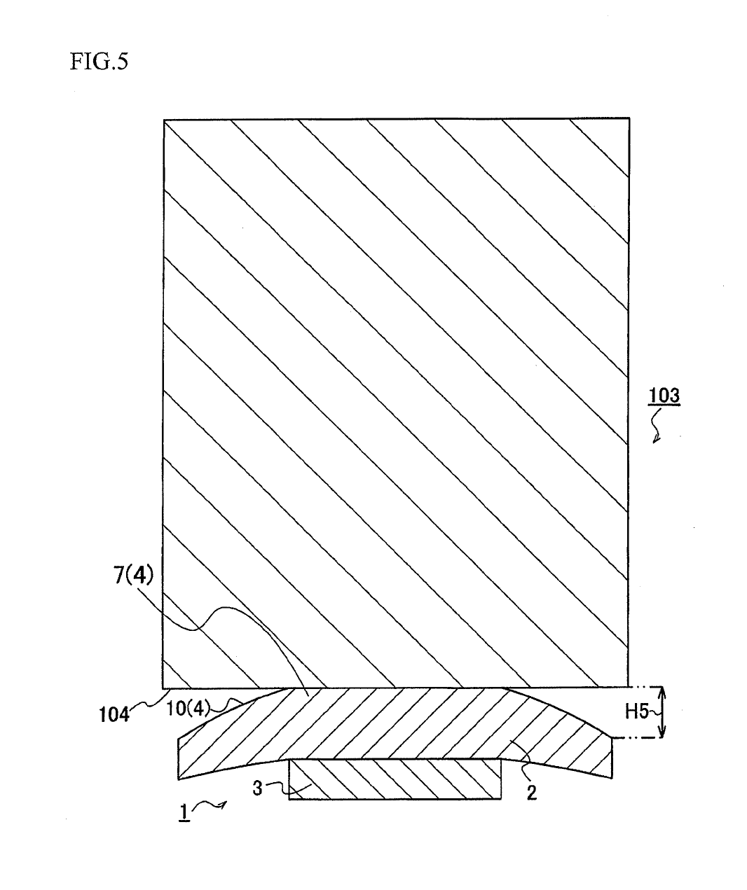

Further, for the setter for firing 1 of the present embodiment, an area ratio of the above-described honeycomb placement surface 4 to the above-described setter supporting surface 5 is specified. Specifically, a value obtained by dividing an area S1 (=(D2/2)²×π) of the honeycomb placement surface 4 of the setter body part 2 by an area S2 (=(D3/2)²×π) of the setter supporting surface 5 of the setter supporting part 3, where the areas S1 and S2 are calculated based on the diameter D2 of the circular honeycomb placement surface 4 and the diameter D3 of the setter supporting surface 5, respectively, is set to be in a range of 1.5 to 20.0, more preferably in a range of 1.8 to 19.0. This specifies the area ratio (=S1/S2) of the setter body part 2 to the setter supporting part 3 that supports the setter body part 2 (refer to FIG. 4).

That is, the area S1 of the honeycomb placement surface 4 is limited to a range of 1.5 times to 20.0 times of the area S2 of the setter supporting surface 5. Here, since each of the honeycomb placement surface 4 and the setter supporting surface 5 has a circular shape, the above-described area ratio can be calculated from the respective diameters D2 and D3. However, the shape of each of the honeycomb placement surface 4 and the setter supporting surface 5 is not limited to the circular shape. For example, in a case where each of the setter body part and the setter supporting part is formed with a polyangular pillar-shaped body, each of the honeycomb placement surface and the setter supporting surface is polygonal. In this case, based on the respective areas of the polygonal honeycomb placement surface and setter supporting surface, the above area ratio is calculated and the calculated value only has to be within the above specified range.

In addition, in the setter for firing 1 of the present embodiment, the setter for firing 1 in which the honeycomb placement surface 4 of the setter body part 2 is configured from the flat part 7 and the curved surface part 10 is shown, but not limited to this, the honeycomb placement surface 4 may be configured from only the flat part without the curved surface part, or from only the curved surface part without the flat part. In the former case, although the contact area between the formed body end face 101 of the honeycomb allied body 100 and the honeycomb placement surface of the setter body part is large, the above specified area ratio only has to be satisfied. In the latter case, although the contact area with the formed body end face 101 of the honeycomb formed body 100 is small, the honeycomb formed body 100 may swing largely due to the movement in the firing furnace and may become unstable. However, if the swing is within an allowable range, the honeycomb placement surface may be configured from only the curved surface part.

Furthermore, in the setter for firing 1 of the present embodiment, a height 113 from the supporting part lower surface 11 in contact with the shelf plate 102 to the setter supporting surface 5 is set to a range of 0.5 mm to 5.0 mm, more preferably to a range of 1.0 mm to 4.0 mm. That is, in a case where the setter body part 2 is placed on the setter supporting part 3, the setter body part 2 is supported with a clearance of at least 0.5 mm provided from the upper surface of the shelf plate 102.

The setter for firing 1 is configured by using a conventionally known ceramic material. Hence, a region of the curved surface part 10 of the setter body part 2 causes a creep phenomenon unique to a ceramic material by being exposed to a high firing temperature in the firing furnace and deforms while keeping gentle fluidity. Particularly, the curved surface part 10 has the clearance formed between the curved surface part 10 and the shelf plate 102, and a force to support the curved surface part 10 from below does not exist. Hence, by the creep phenomenon, a region of the setter body part 2 separate from the setter supporting part 3 (a region of the curved surface part 10) generates a force of gradually hanging down in accordance with its own weight (refer to FIG. 5). Consequently, the curved surface part 10 deforms into a shape which is bulged upward along an axial direction (corresponding to a vertical direction of the paper surface in FIG. 5) of the honeycomb formed body 100. At this time, by specifying the height H3 from the shelf plate 102 to the setter supporting surface 5 to the above range, it is possible to maintain the curved surface part 10 in an optimum state without being affected by the irregularities on the surface of the shelf plate 102 even in a case where the body part side face 8 moves downward. That is, it is possible to maintain a suitable setter shape by the creep phenomenon.

Note that, as shown in FIGS. 4 and 5, other than the above diameters D1, D2, and D3 and the height H3 to the setter supporting surface 5, a height H1 of the honeycomb formed body 100 in the axial direction, a thickness H2 from an upper end 8b to a lower end 8a of the body part side face 8, a height H4 from the upper end 8b of the body part side face 8 before firing to the formed body end face 101, and a height H5 from the upper end 8b of the body part side face 8 after firing to a structure side face 104 of the honeycomb structure 103 are each defined herein. Note that, as described above, in a case where the honeycomb placement surface of the setter body part does not have the curved surface part, the above height H4 from the upper end 8b before firing to the formed body end face 101 is 0 mm.

The setter for firing 1 of the present embodiment is, as described above, formed of a ceramic material. The material is not particularly limited, and, for example, various materials to be used as basic materials of the setter for firing can be used. For example, materials which are converted into cordierite, silicon carbide, or alumina by being fired at high temperatures can be used. Note that, the setter for firing 1 of the present embodiment uses the material formed of the conventionally known mullite.

In addition, the method for forming the setter for firing 1 is not particularly limited. For example, after the general disk-shaped setter for firing is formed, the honeycomb placement surface is subjected to cutting work or the like in accordance with the shapes of the flat part and the curved surface part, and thereby the setter for firing in a desired shape can be manufactured. However, since a large number of setters for firing are used in the firing step, performing the cutting work on each of the setters for firing may lead to complication of manufacturing process and rising of manufacturing cost of the setter for firing.

Thus, for example, the method may use a molding die for press work formed according to a shape of the setter for firing, fill the molding die with ceramic materials serving as raw materials, and form the setter formed body by applying desired press pressure thereto. The setter for firing can be manufactured by applying the press pressure and then firing the setter formed body taken out from the molding die. This makes it possible to manufacture ceramic press setters in a large amount and to use the press setters as the setters for firing of the present invention.

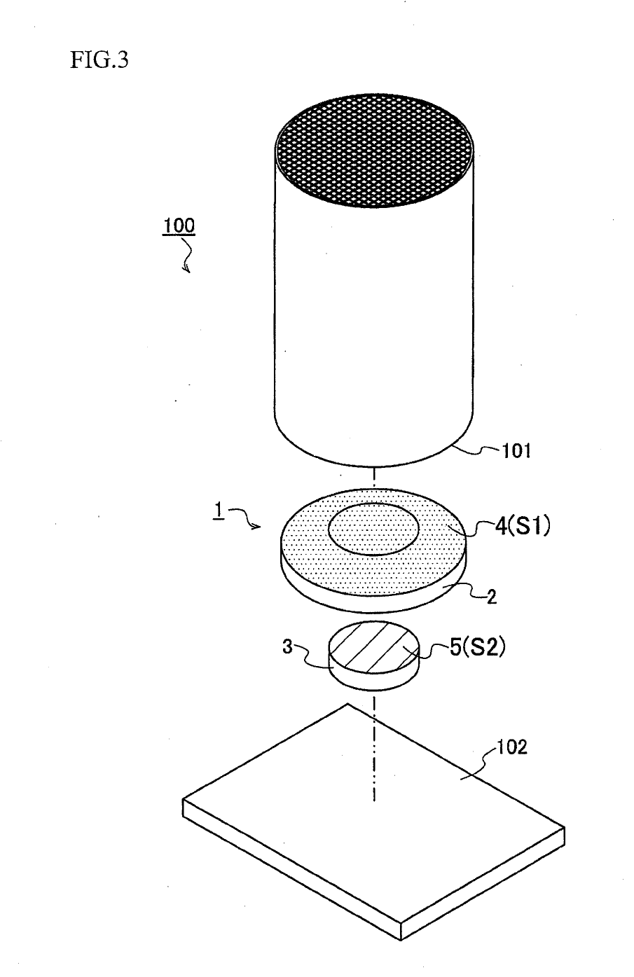

Note that, in the case of above press work, a setter for firing in which the setter body part and the setter supporting part are monolithically formed may be manufactured. That is, in FIG. 3 and the like, the setter body part 2 and the setter supporting part 3 are each shown as separate configurations, but may not be limited to this. In addition, after they are formed in the separate configurations, the body part lower surface 6 of the setter body part 2 and the setter supporting surface 5 of the setter supporting part 3 may be bonded via a desired bonding material to form a monolithic configuration. This improves safety when the honeycomb formed body 100 is placed and moved in the horizontal direction.

In addition, the setter for firing 1 of the present embodiment is set so that a surface roughness (Ra) of the flat part 7 of the honeycomb placement surface 4 is not more than 10 μm. Here, the surface roughness (Ra) is a value measured based on the measurement method described in JIS-B-0601. The flat part 7 is a portion that directly contacts the formed body end face 101 of the honeycomb formed body 100, and the formed body end face 101 gets caught on the setter for firing 1 depending on presence or absence of fine irregularities on the flat part 7, in other words, smoothness of the flat part 7, inhibits equal firing shrinkage, and particularly affects the occurrence of troubles, such as cell deformation. By specifying the surface roughness (Ra) of the flat part 7 to not more than the above numerical value, it is possible to effectively avoid the occurrence of troubles at the time of firing.

By the use of the setter for firing 1 employing the above configuration, the setter body part 2 is placed above the shelf plate 102 with the setter supporting part 3 interposed therebetween, and further bringing at least a part of the formed body end face 101 of the honeycomb formed body 100 into contact with the honeycomb placement surface 4 of the setter body part 2 allows placement of the substantially round pillar-shaped honeycomb formed body 100 in an upright state (FIGS. 3 and 4).

Particularly, since the honeycomb placement surface 4 is configured from the flat part 7 and the curved surface part 10, a placement state when the honeycomb formed body 100 is placed in the upright state is stable, and the contact area with the formed body end face 101 of the honeycomb formed body 100 can be made as small as possible. This stabilizes the horizontal movement in the firing furnace. Furthermore, limiting the surface roughness (Ra) of the flat part 7 to not more than 10 μm allows prevention of catching of the formed body end face 101 at the time of firing shrinkage. Consequently, the occurrence of troubles, such as cell deformation and partition wall cut, is solved, equal firing shrinkage is performed, and a roundness defect in the formed body end face 101 does not occur.

Particularly, since the area of the honeycomb placement surface 4 of the setter body part 2 is made larger than the area of the setter supporting surface 5 of the setter supporting part 3, an outer circumferential region including the body part side face 8 of the setter body part 2 is separated from the shelf plate 102. The setter body part 2, which is formed of a ceramic material, such as mullite, causes a creep phenomenon unique to the ceramic material by being introduced into the high-temperature firing furnace in this state together with the honeycomb formed body 100, and comes to have a bulged shape raised upward as compared with the shape before firing. Consequently, the flat part 7 is gradually narrowed along with firing of the honeycomb formed body 100, and thus troubles of the honeycomb formed body 100, such as cell deformation and partition wall cut, due to contact with the setter for firing 1 occur less. This suppresses reduction in yield at the time of manufacturing the honeycomb structure and allows stable firing of the honeycomb formed body.

At this time, since the shelf plate 102 contacts only the setter supporting part 3 that does not directly contact the honeycomb formed body 100, the difference of firing shrinkage between the shelf plate 102 and the setter for firing 1 does not affect firing of the honeycomb funned body 100.

The setter for firing of the present invention will be described below based on Examples described below, but the setter for firing of the present invention is not limited to these Examples.

### EXAMPLES

(1) Honeycomb Formed Body

As each of the honeycomb formed bodies to be fired, the one having a diameter D1 (honeycomb diameter) of 267 mm and an axial length H1 of 152 mm was used.

(2) Production of a Setter for Firing

Setters for firing of Examples 1 to 10 in which the diameters D2 of the honeycomb placement surface and the diameters D3 of the setter supporting surface are different from each other and the area ratios of D2/D3 satisfy the range of the present invention, and setters for firing of Comparative Examples 1 and 2 that have the area ratios deviating from the range of the present invention were manufactured. Note that, Comparative Examples 3 to 5 are conventional setters for firing without the setter supporting part. Therefore, they have no values, such as the area ratios of D2/D3. Each of these is a press setter and its material is mullite.

(3) Execution of Firing Step

By use of the setters for firing of Examples 1 to 10 and Comparative Examples 1 to 5, the firing step that is one step in the method for manufacturing a honeycomb structure of the present invention was executed on each of the honeycomb formed bodies of the above (1) with the same firing conditions, such as a firing temperature. The items described below were evaluated for the honeycomb structures obtained by firing and the setters for firing. Note that, as the honeycomb formed body to be fired, the one obtained by extruding molding materials (kneaded materials) adjusted to a predetermined compounding ratio by using a well-known extruder (molding step) was used. The firing step includes a shelf plate arrangement step of arranging the shelf plate in a firing furnace, a setter for firing installation step of installing the setter for firing manufactured as described above on the shelf plate, and a honeycomb formed body placement step of placing the honeycomb formed body further on the setter for firing with one formed body end face directed downwardly. Thus, a state was set where the setter for firing was interposed between the honeycomb formed body and the shelf plate. In such a state, the honeycomb formed body was thrown into the firing furnace and fired. Thus, manufacturing of the honeycomb structure was completed (the method for manufacturing a honeycomb structure of the present invention). Note that, each of the setters for firing was subjected to the same firing step 15 times repeatedly. The height H5 from the upper end of the body part side face of the honeycomb structure to the structure end face and presence or absence of cell deformation and partition wall cut of the structure end face were each evaluated after the first firing, after the fifth firing, and after the fifteenth firing. The detail of evaluation items and evaluation criteria is shown below.

(4) Evaluation of Height H5 after Firing

For the height H5 from the upper end of the body part side face to the structure end face after each firing, with the height H5 after the first firing as a reference value, the one having a difference (variation) of less than 0.1 mm between the heights H5 after the fifth firing and after the fifteenth firing and the reference value was evaluated as “A”, the one having the difference in a range of 0.1 min to 0.5 mm was evaluated as “B”, and the one having the difference of not less than 0.5 mm was evaluated as “C”.

(5) Evaluation of Structure End Face

Particularly, the presence or absence of partition wall cut at the time of firing shrinkage was determined by visual checking of the shape of the structure end face of the honeycomb structure for each of the (first, fifth, and fifteenth) firing. Note that, three-level-evaluation was performed such that a case without a partition wall cut or cell deformation was evaluated as “A”, a case with a slight cell deformation was evaluated as “B” because it is allowable, and a case with a large partition wall cut or cell deformation was evaluated as “C”.

Table 1 below shows specifications of the setters for firing of Examples 1 to 10 and Comparative Examples 1 to 5, the heights H5 and its variations and the evaluation results of the structure end face after the first firing, after the fifth firing, and after the fifteenth firing.

TABLE 1

| | | | | | | | | | | | Structure | after | Structure | | Structure |
|---|---|---|---|---|---|---|---|---|---|---|---|---|---|---|---|
| | | | | | | | | Area | | after | end face | fifth | end face | after | end face |
| | Setter | | | | | | | ratio | | first | after | firing | after | fifteenth | after |
| | ma- | D/1 | H1/ | D2/ | H2/ | H3/ | D3/ | (=S1/ | | firing | first | H5/ | fifth | firing | fifteenth |
| | terial | mm | mm | mm | mm | mm | mm | S2) | H4/mm | H5/mm | firing | mm | firing | H5/mm | firing |
| Example 1 | Mullite | 267 | 152 | 147 | 8 | 1 | 44 | 11.2 | 0.06 | 0.95 | A | A | A | A | A |
| Example 2 | Mullite | 267 | 152 | 147 | 8 | 1 | 59 | 6.2 | 0.13 | 0.98 | A | A | A | A | A |
| Example 3 | Mullite | 267 | 152 | 147 | 8 | 2 | 59 | 6.2 | 0.09 | 1.57 | A | A | A | A | A |
| Example 4 | Mullite | 267 | 152 | 147 | 8 | 1 | 100 | 2.2 | 0.04 | 0.64 | A | A | A | A | A |
| Example 5 | Mullite | 267 | 152 | 250 | 8 | 1 | 59 | 18.0 | 0.07 | 0.78 | A | A | A | A | A |
| Example 6 | Mullite | 267 | 152 | 250 | 8 | 1 | 75 | 11.1 | 0.08 | 0.70 | A | A | A | A | A |
| Example 7 | Mullite | 267 | 152 | 250 | 8 | 2 | 75 | 11.1 | 0.15 | 1.74 | A | A | A | A | A |
| Example 8 | Mullite | 267 | 152 | 250 | 8 | 1 | 100 | 6.3 | 0.03 | 0.50 | A | A | A | A | A |
| Example 9 | Mullite | 267 | 152 | 250 | 8 | 2 | 100 | 6.3 | 0.08 | 1.65 | A | A | A | A | A |
| Example 10 | Mullite | 267 | 152 | 250 | 8 | 4 | 75 | 11.1 | 0.33 | 2.16 | A | A | A | A | A |
| | | | | | | | | | (with | | | | | | |
| | | | | | | | | | irregu- | | | | | | |
| | | | | | | | | | larities) | | | | | | |
| Comparative | Mullite | 267 | 152 | 147 | 8 | 1 | 135 | 1.2 | 0.03 | with | B | C | Partition | — | — |
| Example 1 | | | | | | | | | | irregu- | | | wall cut | | |
| | | | | | | | | | | larities | | | | | |
| Comparative | Mullite | 267 | 152 | 250 | 8 | 1 | 50 | 25.0 | 0.07 | 0.73 | A | C | Partition | — | — |
| Example 2 | | | | | | | | | | | | | wall cut | | |
| Comparative | Mullite | 267 | 152 | 250 | 8 | — | — | — | 0.07 | with | B | C | Partition | — | — |
| Example 3 | | | | | | | | | | irregu- | | | wall cut | | |
| | | | | | | | | | | larities | | | | | |
| Comparative | Mullite | 267 | 152 | 250 | 8 | — | — | — | −0.04 | with | Partition | — | — | — | — |
| Example 4 | | | | | | | | | (with | irregu- | wall cut | | | | |
| | | | | | | | | | irregu- | larities | | | | | |
| | | | | | | | | | larities) | | | | | | |
| Comparative | Mullite | 267 | 152 | 250 | 8 | — | — | — | 0.63 | 0.38 | A | C | Partition | — | — |
| Example 5 | | | | | | | | | | | | | wall cut | | |

### Considerations: Examples 1 to 10

As shown in Table 1, in a case where the area ratio was within a range specified for the setter for firing of the present invention, each of the variations of the height H5 after the fifth firing and after the fifteenth firing was not more than 0.1 mm with respect to the height H5 after the first firing, further there existed no partition wall cut or cell deformation on the structure end face of each of the honeycomb structures after the first firing, after the fifth firing, and after the fifteenth firing, and the evaluation result of “A” was obtained (excluding Example 10). Thus, it was confirmed that in the honeycomb formed body fired using the setter for firing of the present invention, isotropic firing shrinkage can be performed at the time of firing step. Further, even in a case where the setter for firing was used repeatedly and the firing was performed 15 times, firing of the honeycomb formed body could be performed favorably, and it was confirmed that the setter for firing has a satisfactory durability.

Note that, in a case of a setter for firing having the height H3 of 4 mm from the supporting part lower surface to the setter supporting surface (Example 10), the value of the height H4 from the upper end of the body part side face to the formed body end face was significantly large as compared with the case of the other Examples 1 to 9, and further irregularities were large. Thus, the variation of the height H5 after the fifth firing was evaluated as “C”, but it was shown that the variation would not be a practical problem.

### Considerations: Comparative Examples 1 to 5

On the other hand, in a case where the area ratio was outside the range specified for the setter for firing of the present invention (Comparative Examples 1 and 2), each of the variations of the height H5 after the fifth firing was evaluated as “C”, and further the partition wall cut occurred on the structure end face after the fifth firing. Thus, validity of specifying the area ratio in the range of 1.5 to 20.0 was confirmed. Note that, since the variation of the height H5 of the setter for firing after the fifth firing was large, further firing after that was not performed (see “-” in Table 1).

Meanwhile, in a case without the configuration of the setter supporting part in the setter for firing of the present invention, that is, in the case of conventional setter for firing (Comparative Examples 3 and 5), similarly to Comparative Examples 1 and 2, the height H5 after the fifth firing was evaluated as “C” and the partition wall cut was confirmed on the structure end face. Therefore, similarly to Comparative Examples 1 and 2, further firing after that was not performed. In addition, in the case of the setter for firing of Comparative Example 4, the partition wall cut occurred on the structure end face after the first firing, and therefore further firing after that was not performed.

As described above, in a case where the area ratio deviated from the range of the present invention, or in a case without the setter supporting part, the setter for firing could withstand the firing of the honeycomb formed body from once to only several times and could not be used repeatedly 15 times or more, unlike the setter for firing of the present invention. Further, the occurrence of the partition wall cut or cell deformation was observed in a large amount on the structure end face. As described above, using the setter for firing of the present invention makes it possible to manufacture the honeycomb structure in a stable condition.

The setter for firing of the present invention can be particularly effectively used in the firing step that is one step of the method for manufacturing a honeycomb structure for manufacturing a ceramic honeycomb structure to be used, for example, as catalyst carriers for purifying automobile exhaust gas. Furthermore, the method for manufacturing the honeycomb structure using the setter for firing makes it possible to stably manufacture the honeycomb structure from the honeycomb formed body.

### DESCRIPTION OF REFERENCE NUMERALS

1: setter for firing, 2: setter body part, 3: setter supporting part, 4: honeycomb placement surface, 5: setter supporting surface, 6: body part lower surface, 7: flat part, 8: body part side face, 8a: lower end, 8b: upper end, 9: flat part outer edge, 10: curved surface part, 11: supporting part lower surface, 100: honeycomb formed body, 101: formed body end face, 102: shelf plate, 103: honeycomb structure, 104: structure end face, D1: diameter of formed body end face, D2: diameter of honeycomb placement surface, D3: diameter of setter supporting surface, H1: axial length of honeycomb formed body, H2: thickness of body part side face, H3: height from supporting part lower surface to setter supporting surface, H4: height from upper end of body part side face before firing to formed body end face, H5: height from upper end of body part side face after firing to structure end face, S1: area of honeycomb placement surface, and S2: area of setter supporting surface.

1. A setter for firing used for firing a honeycomb formed body and interposed between the honeycomb formed body and a shelf plate, the setter for firing comprising:
a setter body part having a honeycomb placement surface at least partially in contact with a formed body end face of the honeycomb formed body and placing the honeycomb formed body on the honeycomb placement surface; and
a setter supporting part that is provided below the setter body part and supports the setter body part, wherein
a value obtained by dividing an area of the honeycomb placement surface of the setter body part by an area of a setter supporting surface of the setter supporting part that contacts the setter body part is in a range of 1.5 to 20.0.

2. The setter for firing according to claim 1, wherein a height of the setter supporting part from a supporting part lower surface that contacts the shelf plate to the setter supporting surface is in a range of 0.5 to 5.0 mm.

3. The setter for firing according to claim 1, wherein the setter body part is a ceramic press setter.

4. The setter for firing according to claim 1, wherein the setter body part and the setter supporting part are monolithically formed.

5. The setter for firing according to claim 1, wherein
the honeycomb placement surface has
a flat part that contacts the formed body end face, and
a curved surface part that is formed around the flat part and formed with a bulged curved surface that is raised from a body part side face to an outer edge of the flat part, and
a surface roughness of the flat part is not more than 10 μm.

6. The setter for firing according to claim 1, wherein at least one of the honeycomb placement surface of the setter body part and the setter supporting surface of the setter supporting part exhibits a circular shape.

7. The setter for firing according to claim 1, wherein at least one of the setter body part and the setter supporting part is mullite.

8. A method for manufacturing a honeycomb structure using a setter for firing, the method comprising:
a molding step of extruding a honeycomb formed body from a molding material; and
a firing step of firing the honeycomb formed body obtained by the molding step,
the firing step including
a shelf plate arrangement step of arranging a shelf plate in a firing furnace,
a setter for firing installation step of installing the setter for firing on the arranged shelf plate with the setter supporting part facing the shelf plate, the setter for firing including a setter body part having a honeycomb placement surface at least partially in contact with a formed body end face of the honeycomb formed body and capable of placing the honeycomb formed body on the honeycomb placement surface, and
a setter supporting part that is provided below the setter body part and supports the setter body part, wherein a value obtained by dividing an area of the honeycomb placement surface of the setter body part by an area of a setter supporting surface of the setter supporting part that contacts the setter body part is in a range of 1.5 to 20.0, and
a honeycomb formed body placement step of placing the honeycomb formed body on the setter for firing with the formed body end face directed downwardly and placing the honeycomb formed body in the firing furnace with the setter for firing interposed between the honeycomb formed body and the shelf plate.
